(19) United States
(12) Patent Application Publication
(10) Pub. No.: US 2001/0055632 A1
(43) Pub. Date: Dec. 27, 2001

(54) Preform mold

(76) Inventor: Frank E. Semersky, Toledo, OH (US)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 09/863,742

(22) Filed: May 23, 2001

Related U.S. Application Data
(60) Provisional application No. 60/207,879, filed on May 30, 2000.

(51) Int. Cl. B29C 33/42; B29C 49/00

(52) U.S. Cl. 425/525; 425/533

(57) ABSTRACT

A mold for molding a plastic preform having a threaded finish and a spaced apart support ledge formed of two mating mold components having alternately raised and lowered transverse portion, such that when joined the mating surfaces meet to form mold cavities for forming the threaded finish and the support ledge.

This application claims the benefit of U.S. Provisional Patent Application Ser. No. 60/207,879, filed May 30, 2000.

The present invention relates to the molding of preforms for use in the blow molding of plastic bottles having a threaded finish on the neck of the bottle and a spaced support ledge.

### BACKGROUND OF THE INVENTION

In the manufacture of plastic bottles having threaded finish and a spaced support ledge, the molds used to form the preform require split molds which are opened and closed laterally of the longitudinal axis of the preform.

### SUMMARY OF THE INVENTION

It is an object of the present invention to produce a preform having a threaded finish and a spaced apart support ledge wherein split molds may be utilized which are opened and closed axially of the preform.

Another object of the invention is to produce a mold for forming a plastic preform wherein the number of preforms which can be manufactured on a given size mold is materially increased.

The above, as well as other objectives of the invention may be achieved by a mold for molding a plastic preform having a threaded finish and a spaced apart support ledge comprising a first mold body having a central axis including a first annular array of spaced apart mold cavities, and a second annular array of spaced apart mold cavities interdigitated between adjacent ones of the mold cavities of the first annular array and axially offset from the first annular array; and a second mold body having a central axis aligned with the central axis of said first mold body including a first annular array of spaced apart mold cavities to cooperate with the mold cavities of the first annular array of said first mold body to form lug threads, and a second annular array of spaced apart mold cavities to cooperate with the mold cavities the second annular array of said first mold body to form the support ledge, the second annular array of spaced apart mold cavities of said second mold body interdigitated between adjacent ones of the mold cavities of the first annular array of said second mold body and axially offset from the first annular array.

### BRIEF DESCRIPTION OF THE DRAWINGS

The above objects and advantages of the invention will become readily apparent to those skilled in the art from reading the following detailed description of the invention when considered in the light of the accompanying drawings, in which:

FIG. 1 is an exploded elevational view of a mold for forming plastic preforms incorporating the features of the invention; and

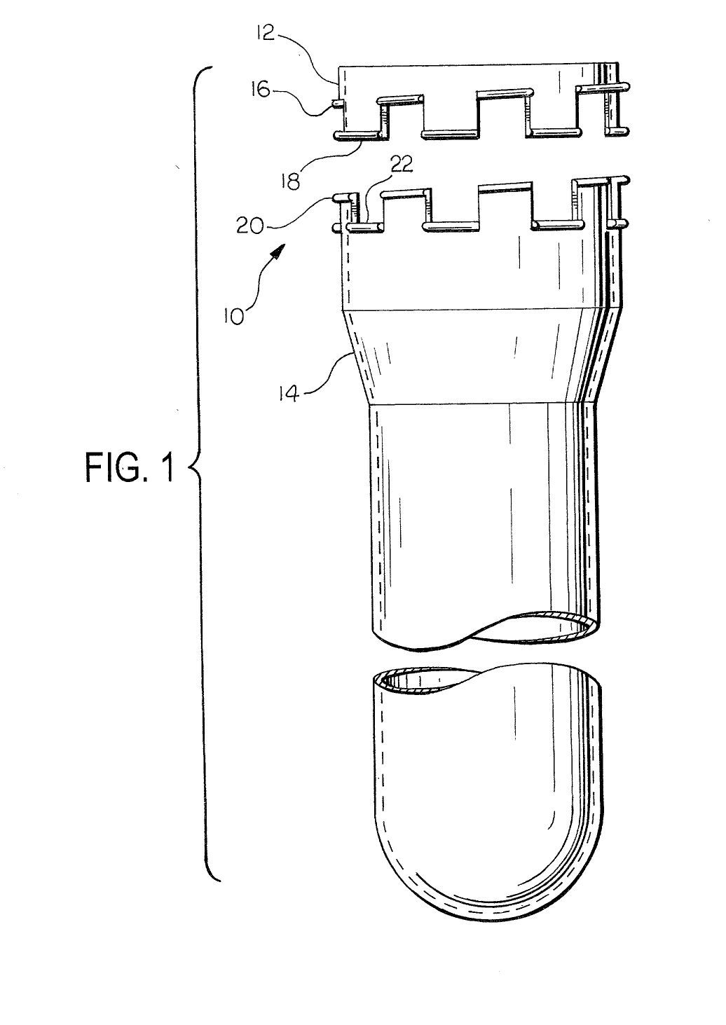

FIG. 2 is a top plan view of the mold illustrated in FIG. 1.

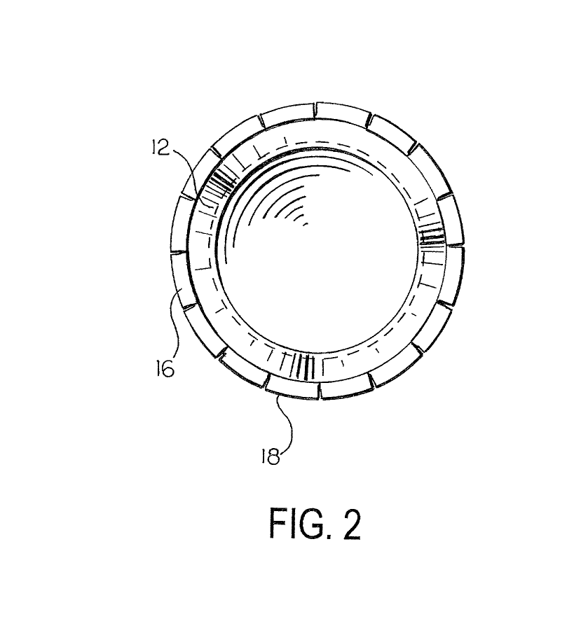

### DETAILED DESCRIPTION OF THE ILLUSTRATED EMBODIMENT

Referring to the drawings, there is illustrated a mold for forming a plastic preform having a threaded finish and a spaced apart support ledge.

In order to transfer preforms in blow molding machines, such as manufactured by Side1, the preforms must typically have two separate support annuli of material projecting laterally outwardly from the periphery of the preform. One of the annuli is required to enable the preform to be manipulated through the unscrambler. This annulus also determines the penetration and the final seating of the preform when the preform is transferred to the blow mold.

The other of the annuli provides a positive feature for the gripper mechanism to grip during the transfer of the preform from the heating mandrel into the blow mold.

Generally, the presence of the two annuli requires that the upper neck portion of the preform be formed with thread splits so that the release of the preform from the mold can be accomplished.

However, in the present invention, the threaded section of the neck of the preform as well as the support ledge are segmented in such a fashion that the cooperating molds containing the mold cavities for forming the preform may be opened and closed by movement along the longitudinal axis as distinguished from being opened and closed by movement of the cooperating mold cavities laterally of the longitudinal axis.

Obviously, the axial movement of the cooperating molds requires less operating space than when lateral movement of the cooperating molds is utilized.

In the drawings, there is illustrated an embodiment of the invention. More particularly, there is shown a two component mold 10 for forming plastic preforms. The mold 10 includes an upper mold component 12 and a cooperating lower mold component 14. It will be noted that the mold components 12 and 14 are hollow cylindrical forms of annular cross-sections.

The upper mold component 12 is annular in shape and is configured with mold cavities which cooperate with mold cavities formed in the lower mold component 14 for forming lug threads in the finish of a final blow molded bottle, and an associate support ledge.

More specifically, the upper mold component 12 is provided with an annular array of spaced apart mold cavities 16 used in forming the lug threads on a plastic preform and an annular array of spaced apart mold cavities 18. It will be noted that the mold cavities 18 are interdigitated between adjacent ones of the mold cavities 16 and are axially offset therefrom. The offset relationship between the mold cavities 16 and 18 determines the spacing between the array of lug threads and the support ledge incorporated on the molded plastic preform.

The lower mold component 14 is generally an elongate hollow cylinder in shape and is provided at the uppermost end with an annular array of spaced apart mold cavities 20 in facing relation to the mold cavities 16 of the upper mold component 12. The facing mold cavities 16 and 20 cooperate when the mold components 12 and 14 are closed to form an annular array of laterally outwardly projecting lug threads on the plastic preform which is injection molded.

The lower mold component 14 is provided with an annular array of spaced apart mold cavities 22 which are interdigitated between adjacent ones of the mold cavities 20 and are offset therefrom. Manifestly, the offset spacing of the mold cavities 20 and 22 is the same as the offset relation between the cooperating mold cavities 16 and 18, respectively.

In use, a suitable insert is positioned within the hollow interim of the mold 10 and the mold components 12 and 14 are axially assembled such that the mold cavities 16, 20 and 18, 22 are brought together in facing relationship. After the mold is in the closed position, the plastic material is injected into the space between the outer surface of the insert and the facing inner surface of the mold components 12 and 14. After the plastic has solidified, the mold components 12 and 14 are opening by moving the components axially away from one another. Hence, the molded preform may be suitably ejected.

While the description and the accompanying drawings disclose the preform having lug threads formed by the cooperating mold cavities 16 and 20, it will be understood that the preform could likewise be formed with a single interrupted helix thread or be provided with an annular array of transfer lugs.

In accordance with the provisions of the patent statutes, the present invention has been described in what is considered to represent its preferred embodiment. However, it should be understood that the invention can be practiced otherwise than as specifically illustrated and described without departing from its spirit or scope.

What is claimed is:

1. A mold for molding a plastic preform having a threaded finish and a spaced apart support ledge comprising:
a first mold body having a central axis including a first annular array of spaced apart mold cavities and a second annular array of spaced apart mold cavities interdigitated between adjacent ones of the mold cavities of the first annular array and axially offset from the first annular array; and
a second mold body having a central axis aligned with the central axis of said first mold body including a first annular array of spaced apart mold cavities to cooperate with the mold cavities of the first annular array of said first mold body to form the threaded finish, and a second annular array of spaced apart mold cavities to cooperate with the mold cavities of the second annular array of said first mold body to form the support ledge, the second annular array of spaced apart mold cavities of said second mold body interdigitated between adjacent ones of the mold cavities of the first annular array of said second mold body and axially offset from the first annular array.

2. A mold for molding a plastic preform having a threaded finish and a spaced apart support ledge comprising:
a first cylindrical mold body having a central axis including a first annular array of spaced apart mold cavities and a second annular array of spaced apart mold cavities interdigitated between adjacent ones of the mold cavities of the first annular array and axially offset from the first annular array; and
a second cylindrical mold body having a central axis aligned with the central axis of said first cylindrical mold body including a first annular array of spaced apart mold cavities to cooperate with the mold cavities of the first annular array of said first cylindrical mold body to form the threaded finish and a second annular array of spaced apart mold cavities to cooperate with the mold cavities of the second annular array of said first cylindrical mold body to form the support ledge, the second array of spaced apart mold cavities of said second cylindrical mold body interdigitated between adjacent ones of the mold cavities of the first annular array of said second cylindrical mold body and axially offset from the first annular array.

3. A mold for molding a plastic preform having a threaded finish and a spaced apart support ledge as defined in claim 2 wherein the first array of spaced apart mold cavities and the second array of spaced apart mold cavities of said first cylindrical mold body and said second cylindrical mold body extend radially outwardly from the central axes of said first and said second mold body.
